(19) United States
(12) Patent Application Publication
(10) Pub. No.: US 2012/0318193 A1
(43) Pub. Date: Dec. 20, 2012

(54) DEVICE FOR APPLYING ADHESIVES, OPTIONALLY IN A RETROFIT-FREE MANNER

(75) Inventor: Stefan Specht, Obersulm (DE)

(73) Assignee: Friz Kaschiertechnik GmbH, Weinsberg (DE)

(21) Appl. No.: 13/582,023

(22) PCT Filed: Sep. 15, 2011
(86) PCT No.: PCT/EP11/66001

§ 371 Date: Aug. 30, 2012

(30) Foreign Application Priority Data
Sep. 22, 2010 (EP) 10178285.2

(51) Int. Cl. B05C 1/12

(52) U.S. Cl. 118/202; 118/258; 118/255

(57) ABSTRACT

The invention relates to a device for applying adhesives, optionally in a retrofit-free manner, in particular PUR adhesives and dispersion adhesives, in particular PVAc adhesives, to planar objects, in particular panel-shaped components, which are made of wood, derived timber products, plastic material or the like at least in some sections, comprising at least one application roller for applying the adhesive and at least one metering roller for metering out the adhesive, the rollers being arranged next to one another forming a tapering gap into which the adhesive is supplied, wherein a glue reservoir for hot-melt adhesive and a glue reservoir for dispersion adhesive are provided, which are connected to the gap by means of a supply system or adhesive.

### TECHNICAL DOMAIN

The present invention relates to a device for applying hot-melt adhesives, optionally in a retrofit-free manner, in particular PUR adhesives and dispersion adhesives, in particular PVAc adhesives, to planar objects, in particular panel-shaped components, which are made of wood, derived timber products, plastic material or the like, at least in some sections.

### PRIOR ART

In the domain of surface lamination in the furniture and components industry glue application machines are known which apply glue to the substrate with the aid of rollers. The outfitting and structural design of such machines have until now been specific to the type of glue to be processed. There are therefore machines with which low-viscous glues such as for example solvent-based adhesives or PVAc adhesives (white glues) can be applied. Furthermore, there are glue application machines which are suitable purely for the application of hot-melt adhesives.

DE 20 2004 018 588 discloses combination machines in which the application of different glue types is made possible by changing machine components (cassette system).

G 85 07 105.6 discloses a glue application machine which makes it possible by means of a line and nozzle system that can be switched on and off to apply two different types of hot-melt adhesive next to one another on a strip of material.

It is therefore desirable to enable users in the furniture and components industry, who have previously mainly used PVAc glues, to also be able to process PUR adhesives without purchasing a new, specialized machine.

### DESCRIPTION OF THE INVENTION

It is therefore the object of the present invention to make available a device for applying adhesives which makes it possible to apply, optionally in a retrofit-free manner, hot-melt adhesives, in particular PUR adhesives and dispersion adhesives, in particular PVAc adhesives, to planar objects, in particular panel-shaped components, which are made of wood, derived timber products, plastic material or the like, at least in some sections.

According to the invention this object is achieved by a device for applying adhesives, optionally in a retrofit-free manner, having the features of claim 1. Advantageous embodiments and improvements of the invention are given in the sub-claims.

A device according to the invention is set up to apply, optionally without retrofitting being required, both hot-met adhesives, in particular PUR adhesives, and dispersion adhesives, in particular PVAc adhesives, to planar objects. Preferably the device is provided for applying adhesive to panel-shaped components which are made, at least in some sections, of wood, derived timber products, plastic or the like. The term adhesive is to be understood as also including the glues that correspond to the aforementioned categories.

The device has at least one application roller for applying the adhesive and at least one metering roller for metering out the adhesive, the rollers being arranged next to one another forming a tapering gap into which the adhesive is supplied. During operation the rollers rotate, the adhesive passing through the gap between the rollers. The distance between the metering roller and the application roller thereby defines the gap width which restricts the amount of adhesive that is applied to the application roller and by the latter to the workpiece. A larger gap width allows more adhesive to pass onto the application roller and so onto the workpiece.

According to the invention both a glue reservoir for hot-melt adhesive and a glue reservoir for dispersion adhesive are provided, and these are connected to the gap by a supply system for adhesive. Since both adhesive types are stored on the device and can be supplied to the latter, it is possible to supply one of the adhesives to the device, optionally in a retrofit-free manner. For this purpose the supply system has corresponding supply lines and valves which enable the supply of one type of adhesive, optionally in a retrofit-free manner.

According to a preferred further development the application roller has an outer coating, in particular a rubber coating, which prevents water components of the dispersion adhesive from diffusing into the application roller. Due to this, the application roller can also be produced from base materials into which the dispersion adhesives would diffuse and which could not be used without a coating.

According to one preferred embodiment of the invention, particularly preferably the metering roller or preferably also the application roller are optionally heatable. In this way hot-melt adhesives can be heated to the desired temperature for use. Furthermore, the viscosity of the adhesives can be adapted very well to the process parameters by means of the temperature.

According to one preferred embodiment of the invention the device has at least one adhesive seal which seals the gap between the application roller and the metering roller on the face side such that the adhesive in the tapering gap is largely prevented from running outwards in the axial direction of the rollers. Preferably, two adhesive seals are provided which seal the gap on both sides at the ends of the shafts in the axial direction of the shafts. The adhesive supplied to the gap, which collects here in a type of channel, is thus prevented from running to the ends of the rollers. Preferably the adhesive seal has individual segments, in particular plastic jaws, that can be shifted towards one another, which lie tightly against one another under pressure. In this way the gap, which in profile is formed by the bends of the metering roller and the application roller, is produced particularly flexibly and accurately, and this provides a high degree of tightness at the side.

According to one preferred embodiment of the invention the temperature of the metering roller and/or the application roller can be adjusted. Since different adhesives should be used flexibly, this embodiment offers the advantage that the temperature of the respective roller can be adapted optimally to the requirements with regard to the processing temperature of the respective adhesive.

According to one preferred embodiment of the present invention two separate adhesive supply systems are provided. In this way one can change particularly easily between the use of the individual adhesive types because it is not necessary to clean a common supply line.

The structure of the rubber coating of the application roller prevents water components of the dispersion adhesive from diffusing in. Since thorough cleaning of the machine must take place when the adhesive is changed, one hardly need worry about moisture being carried into the PUR glue reservoir. Experiments have shown that the effect is no greater than occurs anyway due to the air humidity that is normally present. Leading on from this, the invention consists of no machine components having to be changed. The invention further consists of equipping the metering roller with heating that can be switched off. For the processing of PUR adhesive the glue reservoir is advantageously permanently heated over the metering roller. When changing to the processing of dispersion adhesives (PVAc) this heating is simply switched off because PVAc adhesive is processed when cold. When changing back to processing PUR the start-up of the roller heating causes additional evaporation of any residual moisture that is still present. A further component of the invention is the equipping of the machine with two separate glue supply systems, one for PUR adhesives and one for dispersion adhesives.

### BRIEF DESCRIPTION OF THE DRAWINGS

In the following the invention is described in more detail using exemplary embodiments with reference to the attached figures of the drawings.

The figures show as follows:

FIG. 1 a diagrammatic perspective partial illustration of a device according to the invention for applying adhesives, optionally in a retrofit-free manner; and

FIG. 2 a diagrammatic perspective illustration of a device according to the invention for applying adhesives, optionally in a retrofit-free manner.

In the figures the same reference numbers designate the same components or components with an identical function, unless specified to the contrary.

### DETAILED DESCRIPTION OF THE PREFERRED EMBODIMENTS

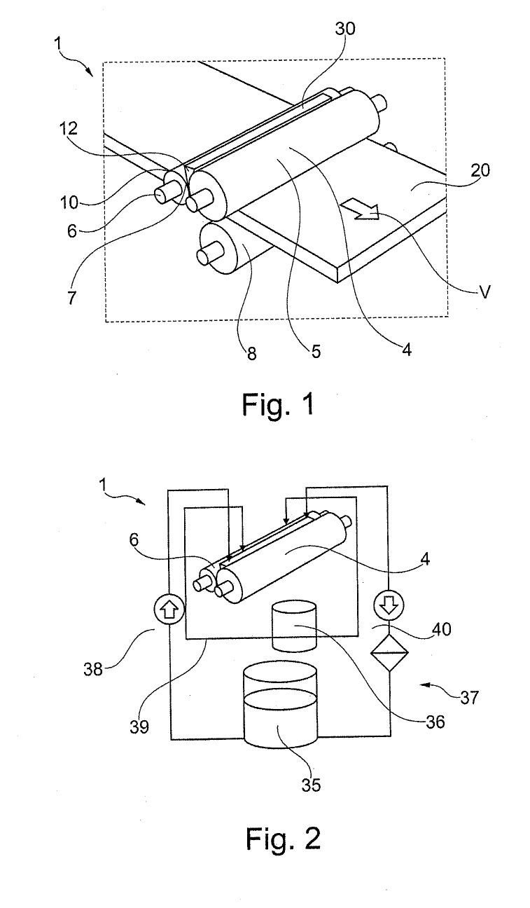

FIG. 1 shows a diagrammatic perspective partial illustration of a device 1 according to the invention for applying adhesives, optionally in a retrofit-free manner. A workpiece 20 to be coated is arranged between an application roller 4 and a metering roller 6 on one side, and a counter-pressure roller 8 on the other side. The application roller 4 is arranged sufficiently close to the metering roller 6 that they form a tapering gap 7. Adhesive 30 is located in this gap 7.

During operation the workpiece 20 is conveyed in the feed direction V. Here the application roller 4 rolls over the workpiece 20. Adhesive 30 is thereby supplied continuously to the gap 7. The adhesive 30 passes in a defined quantity according to the gap width through the gap between the application roller 4 and the metering roller 6 onto the lower part of the application roller 4 and finally onto the workpiece 20. In this way the workpiece 20 is coated with the adhesive 30. In this exemplary embodiment the metering roller 6 can be heated in order to heat the adhesive 30. Furthermore, the application roller 4 has an outer coating 5, here a rubber coating, which prevents water components from diffusing into the application roller 4 when using dispersion adhesive 30. An adhesive seal 10 is provided which seals the gap 7 between the application roller 4 and the metering roller 6 on the face side such that the adhesive 30 in the tapering gap 7 is largely prevented from running outwards in the axial direction of the rollers 4, 6. In this exemplary embodiment the adhesive seal 10 is made up of individual segments 12 that can be shifted towards one another, here plastic jaws which rest tight against one another under pressure. The supply of adhesive 30 is shown by means of FIG. 2.

FIG. 2 shows a diagrammatic perspective illustration of an apparatus 1 according to the invention for applying adhesives, optionally in a retrofit-free manner. The supply system 37 for adhesive 30 is also shown here. A reservoir for hot-melt adhesive 36 is connected to the gap 7 by a supply line for hot-melt adhesive 39. When using the hot-melt adhesive reservoir 36 the metering roller 6 is heated in order to heat the adhesive 30. Optionally, adhesive can also be supplied from the dispersion adhesive reservoir 35 via the supply line for dispersion adhesive 38. A return line with a filter system 40 for dispersion adhesive, in particular PVAc adhesive, is connected to the reservoir for dispersion adhesive 35 and serves to return and prepare the adhesive. When using dispersion adhesive the heating of the metering roller 6 is preferably switched off.

Although the present invention has been described above using preferred exemplary embodiments, it is not restricted to the latter, but can be modified in many ways.

### LIST OF REFERENCE NUMBERS

1 device

4 application roller

5 coating

6 metering roller

7 gap

8 counter-pressure roller

10 adhesive seal

12 segment

20 workpiece

30 adhesive

35 reservoir for dispersion adhesive

36 reservoir for hot-melt adhesive

37 supply system for adhesive

38 supply line for dispersion adhesive

39 supply line for hot-melt adhesive

40 return line with filter system for PVAc adhesive

V feed direction

1. A device (1) for applying hot-melt adhesives, optionally in a retrofit-free manner, in particular PUR adhesives and dispersion adhesives, in particular PVAc adhesives, to planar objects (20), in particular panel-shaped components, which are made of wood, derived timber products, plastic material or the like, at least in some sections,
having at least one application roller (4) for applying the adhesive (30) and at least one metering roller (6) for metering out the adhesive (30), the rollers being arranged next to one another forming a tapering gap (7) into which the adhesive (30) is supplied, a glue reservoir (36) for hot-melt adhesive and a glue reservoir (35) for dispersion adhesive being provided, these reservoirs being connected to the gap (7) by a supply system (37) for adhesive (30).

2. The device (1) according to claim 1,
characterized in that
the application roller (4) has an outer coating (5), in particular a rubber coating, which prevents water components of the dispersion adhesive (30) from diffusing into the application roller (4).

3. The device (1) according to claim 1 or 2,
characterized in that
the metering roller (6) and/or the application roller (4) are optionally heatable.

4. The device (1) according to any of the preceding claims,
characterized in that
a counter-pressure roller (8) is provided such that when applying the adhesive the workpiece (20) is passed between the application roller (4) and the counter-pressure roller (6).

5. The device (1) according to any of the preceding claims,
characterized in that
the device has at least one adhesive seal (10) which seals the gap (7) between the application roller (4) and the metering roller (6) on the face side such that the adhesive (30) in the tapering gap (7) is largely prevented from running outwards in the axial direction of the rollers (4, 6).

6. The device (1) according to claim 5,
characterized in that
two adhesive seals (10) are provided which seal the gap (7) on both sides at the ends of the rollers (4, 6) in the axial direction of the rollers (4, 6).

7. The device (1) according to claim 6,
characterized in that
the adhesive seal (10) has individual segments (12), in particular plastic jaws, that can be shifted towards one another, which lie tightly against one another under pressure.

8. The device (1) according to any of the preceding claims,
characterized in that
the temperature of the metering roller (6) and/or of the application roller (4) can be adjusted.

9. The device (1) according to any of the preceding claims,
characterized in that
the distance between the metering roller (6) and the application roller (4) can be adjusted.

10. The device (1) according to any of the preceding claims,
characterized in that
two separate adhesive supply lines (38, 39) are provided for the different adhesives.
